(19) United States
(12) Patent Application Publication
(10) Pub. No.: US 2016/0021664 A1
(43) Pub. Date: Jan. 21, 2016

(54) BASE STATION AND COMMUNICETION METHOD THEREOF

(71) Applicant: Industrial Technology Research Institute, Hsinchu (TW)

(72) Inventor: Kuan-Hung Chou, Changhua County (TW)

(21) Appl. No.: 14/799,595

(22) Filed: Jul. 15, 2015

Related U.S. Application Data
(60) Provisional application No. 62/024,987, filed on Jul. 15, 2014.

(30) Foreign Application Priority Data
Jul. 1, 2015 (TW) 104121368

(51) Int. Cl. H04W 72/04; H04W 72/10

(52) U.S. Cl. CPC H04W 72/0453; H04W 72/042; H04W 72/10

(57) ABSTRACT

A base station and a communication method thereof are provided. The base station is adapted to the first wireless communication protocol. The base station includes a transceiver and a processor. The base station sends and receives wireless signals through licensed band which is adopted by the first wireless communication protocol and unlicensed band, wherein the unlicensed band is also adopted by the second wireless communication protocol. The processor configures a first signal which is corresponding to the second wireless communication protocol in an idle transmission resource of a second signal or an idle transmission resource around the second signal which is corresponding to the first wireless communication protocol.

The transceiver transmits the first signal and the second signal to the unlicensed band to maintain transmission resources of the base station in the unlicensed band. The base station selectively or simultaneously uses the licensed band and the unlicensed band.

### CROSS-REFERENCE TO RELATED APPLICATION

This application claims the priority benefits of U.S. provisional application Ser. No. 62/024,987, filed on Jul. 15, 2014, and Taiwan application serial no. 104121368, filed on Jul. 1, 2015. The entirety of each of the above-mentioned patent applications is hereby incorporated by reference herein and made a part of this specification.

### TECHNICAL FIELD

The disclosure is related to a radio communication technique, and particularly to a base station using a licensed band and an unlicensed band and a communication method thereof

### BACKGROUND

In the Long Term Evolution (LTE) wireless communication network among the next-generation cellular systems, LTE release 10 may operate with carrier aggregation, in which the system bandwidth is divided into multiple component carriers (CCs). For example, FIG. 1 is a diagram illustrating bandwidth of the LTE wireless communication system being divided into a plurality of component carriers. With reference to FIG. 1, 100 MHz bandwidth of the LTE wireless communication system is divided into five 20 MHz component carriers (i.e., carriers 101-105). Each of the component carriers may be referred to as a primary component carrier (PCC) or secondary component carrier (SCC) for user equipment (UE). The UE compliant with LTE release 10 may be allocated to a PCC and one or more SCC, so as to provide higher data rates.

However, along as a rapid growth in the amount of wireless traffic, it is predicted that the amount of the wireless network traffic would increase by a factor of 1000 times between the year of 2010 and 2020. To satisfy such huge demand in wireless network traffic, cellular operators of the LTE wireless communication system are looking into a direction from using crowded licensed band toward using an unlicensed band, so as to offload this huge network traffic with more bandwidth. The unlicensed bands may include the industrial, scientific and medical (ISM) bands, television whitespaces (TV WS), and the bands without license requirements. The LTE wireless communication system may need to deploy LTE wireless network related information in the unlicensed band as to provide new function.

However, to communicate in domain of unlicensed band or shared spectrum, other communication devices may wish to use the unlicensed band or the shared spectrum as well. These communication devices may belong to the same or different radio network technique. Furthermore, in the unlicensed band, the communication device of the LTE wireless communication system may not be able to transmit or receive at any given time due to a limitation related to spectrum sharing. Such issue does not exist in the conventional cellular LTE wireless communication system since the transmissions of the communication device of the LTE wireless communication system are scheduled.

In other words, under the consideration of using unlicensed band, how to make the communication of the LTE wireless communication system use the unlicensed band and at the same time coexist with other communication devices using the unlicensed band is one of the concerning subject to those skilled in the art.

### SUMMARY

The disclosure set forth a base station and communication method thereof. The base station configures a first signal corresponding to another communication protocol in an idle transmission resource of a second signal corresponding to the communication protocol adopted by the base station, or an idle transmission resource around the second signal, so as to communicate in unlicensed band adopted by the another communication protocol.

The disclosure provides base station, adapted to a first wireless communication protocol. The base station includes a transceiver and a processor. The transceiver sends and receives wireless signals through a licensed band and an unlicensed band adopted by a first wireless communication protocol, wherein the unlicensed band is also adopted by a second wireless communication protocol, and the first wireless communication protocol and the second wireless communication protocol use different radio access techniques. The processor is coupled to the transceiver. The processor configures a first signal corresponding to the second wireless communication protocol in an idle transmission resource of a second signal corresponding to the first wireless communication protocol or an idle transmission resource around the second signal, transmits the first signal and the second signal through the transceiver to the unlicensed band to maintain transmission resources of the base station on the unlicensed band, and selectively or simultaneously uses the licensed band and the unlicensed band through the first wireless communication protocol and the first signal and the second signal.

The disclosure provides a communication method, adapted to a base station using a first wireless communication protocol. Wireless signals are sent and received, by a transceiver, through a licensed band adapted by the first wireless communication protocol and an unlicensed band, wherein the unlicensed band is also adapted by a second wireless communication protocol, and the first wireless communication protocol and the second wireless communication protocol uses different radio access technique. A first signal corresponding to the second wireless communication protocol is configured in an idle transmission resource of a second signal corresponding to the first wireless communication protocol or an idle transmission resource around the second signal. The first signal and the second signal are transmitted, by the transceiver, to the unlicensed band, wherein the first signal and the second signal are utilized to maintain transmission resource of the base station on the unlicensed band. The licensed band and the unlicensed band are selectively or simultaneously used through the first wireless communication protocol and the first signal and the second signal.

The disclosure provides a base station, adapted to a first wireless communication protocol. The first wireless communication protocol includes the base station and at least one second base station. The first base station includes a transceiver and a processor. The transceiver sends and receives wireless signal through an unlicensed band, and the transceiver receives a signal from the at least one second base station. The processor is coupled to the transceiver. The processor calculates a priority according to the signal from the at least one second base station and ranking a priority list to acquire the priority of the base station in the unlicensed band, the processor first uses a transmission resource having higher priority as compared to the at least one second base station according to the priority list.

The disclosure provides a communication method, adapted to a base station using a first wireless communication protocol. The first wireless communication protocol is adapted by the base station and at least one second base station. Wireless signal is sent and received through a transceiver in an unlicensed band, and a signal corresponding to at least one second base station is received. A priority is calculated according to the signal corresponding to the at least one second base station, and a priority list is ranked to acquire a priority of the base station in the unlicensed band. Wireless resource is used first in which the base station has higher priority as compared to the at least one second base station according to the priority list.

The disclosure provides a communication method, adapted to user equipment (UE). A signal is received from a base station connected to the UE. A priority is acquired within a wireless communication system according to the signal and finding out reserved wireless resource of the base station according to the priority. Message is not received from the base station by the UE to reduce power consumption in the non-reserved wireless resource of the base station.

Based on the above, the embodiments of the disclosure set forth a base station and a communication method thereof. The base station in compliant with a first wireless communication protocol may sent a signal corresponding to a second wireless communication protocol through an idle transmission resource of the first wireless communication protocol, so as to send and receive wireless signal through a licensed band adapted by the first wireless communication protocol and an unlicensed band adapted by the second wireless communication protocol. Furthermore, the base stations having different operators may send a signal related to wireless resource reservation, and accordingly obtain a priority list according to the signal and reserve wireless resource. Thus, the base stations between different operators that use the unlicensed band may use the wireless resource according to the priority list without contention for wireless resource. In addition, a user equipment of the disclosure may determine whether to receive message according to the signal related to the wireless resource reservation of the connected base stations, so as to reduce power consumption.

Several exemplary embodiments accompanied with figures are described in detail below to further describe the disclosure in details.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a diagram illustrating a bandwidth of LTE wireless communication system being divided into a plurality of carrier wave.

FIG. 2 is a diagram illustrating a base station according to an embodiment of the disclosure.

FIG. 3 is a diagram illustrating a coexistence of the LTE wireless network and the WiFi wireless communication system in the unlicensed band according to an embodiment of the disclosure.

FIG. 4A is a diagram illustrating an 802.11 beacon corresponding to the WiFi communication protocol in a discovery reference signal according to an embodiment of the disclosure.

FIG. 4B is a diagram illustrating the 802.11 beacon corresponding to the WiFi communication protocol in the PDCCH according to an embodiment of the disclosure.

FIG. 5A is a diagram illustrating an 802.11 physical layer header corresponding to the WiFi communication protocol in the discovery reference signal 520 according to an embodiment of the disclosure.

FIG. 5B is a diagram illustrating the 802.11 physical layer header corresponding to the WiFi communication protocol in the PDCCH according to an embodiment of the disclosure.

FIG. 6 is a diagram illustrating an 802.11 beacon corresponding to the WiFi communication protocol in a gap of the LTE time division duplex (TDD) according to an embodiment of the disclosure.

FIG. 7 is a diagram illustrating an 802.11 physical layer header corresponding to the WiFi communication protocol in a gap of a reservation signal according to an embodiment of the disclosure.

FIG. 8 is a flow diagram illustrating a communication method of a base station using a first wireless communication protocol on an unlicensed band according to an embodiment of the disclosure.

FIG. 9 is a diagram illustrating a communication of a base station adapted to LTE communication protocol using unlicensed band according to an embodiment of the disclosure.

FIG. 10 is a flow diagram illustrating a communication method between base stations 910 and 920 according to an embodiment of the disclosure.

FIG. 11 is a diagram illustrating a sub-frame transmitted by the base station 910 according to an embodiment of the disclosure.

FIG. 12 is a diagram illustrating sharing of unlicensed band by base stations according to an embodiment of the disclosure.

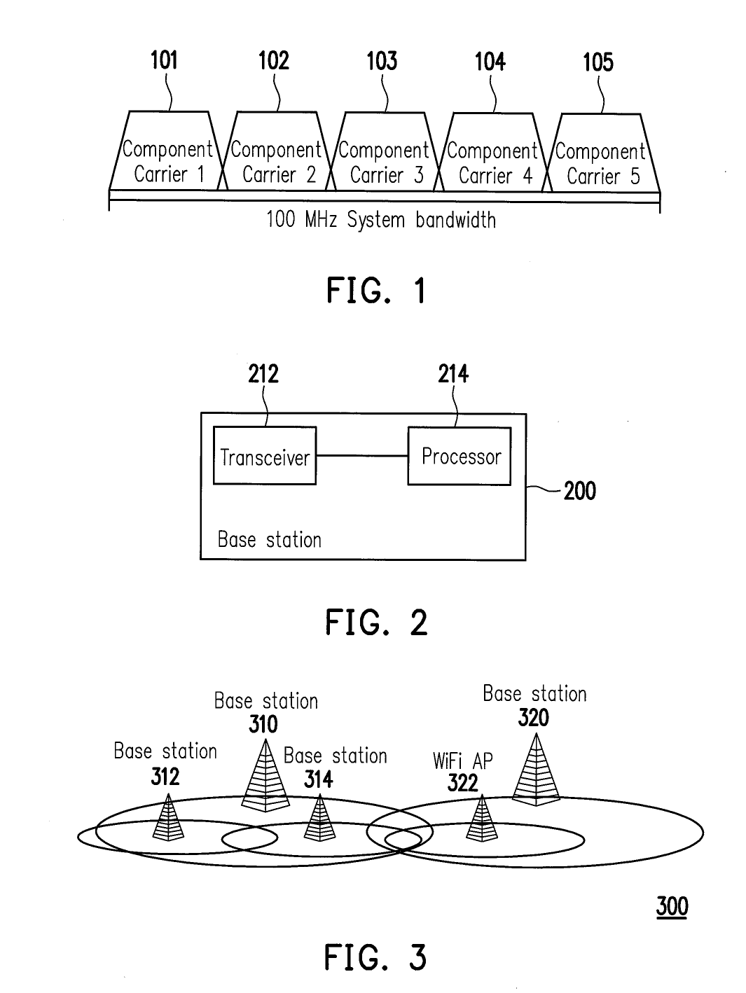

### DETAILED DESCRIPTION OF DISCLOSED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

FIG. 2 is a diagram illustrating a base station 200 according to an embodiment of the disclosure. The base station 200 includes a transceiver 212 and a processor 214. The base station 200 is adapted to a first wireless communication protocol. The first wireless communication protocol is, for example, Long Term Evolution (LTE) protocol, Worldwide Interoperability for Microwave Access (WiMAX) protocol, Cellular radio access network, etc. However, the disclosure is not limited thereto.

The processor 214 is coupled to the transceiver 212. The processor 214 executes a wireless communication function of the base station 200. The transceiver 212 may send and receive wireless signals through a licensed band adapted by a first wireless communication protocol and an unlicensed band adapted by a second wireless communication protocol, where the second wireless communication protocol is a wireless area network protocol compliant with IEEE 802.11 standards, and the first wireless communication protocol and the second wireless communication protocol employs different radio access techniques. However, the disclosure is intended to limit the type of the radio access technique adapted by the first and second wireless communication protocols. In the embodiment, the transceiver 212 may have wireless communication function compliant with the first wireless communication protocol and the second wireless communication protocol. Alternatively, the transceiver 212 may be formed by a cooperation of a transceiver compliant with the first wireless communication protocol and another transceiver compliant with the second wireless communication protocol. The processor 214 may be implemented by a Complex Programmable Logic Device (CPLD), Field Programmable Gate Array (FPGA), microprocessor or any other suitable hardware.

In an embodiment of the disclosure, LTE communication protocol and Wireless Fidelity (WiFi) communication protocol are utilized as example to describe the first wireless communication protocol and the second wireless communication protocol, respectively. However, it is not intended to limit the disclosure. Under such scenario, the base station 200 may be a combination of evolved node B (eNB) compliant with the LTE communication protocol and access point (AP) compliant with WiFi communication protocol.

Notably, there are two methods for deploying LTE communication protocol in the unlicensed band, which are a stand-alone method and a carrier aggregation method. In the stand-alone method, the LTE wireless network may be executed independently without the assistance from the licensed band. In the carrier aggregation method, a LTE wireless network may use the unlicensed bands as secondary component carriers (SCC), and the control may be assisted by licensed bands utilized by the LTE wireless network. However, a coexistence issue should be considered given the nature of the unlicensed band. The LTE wireless network should consider the coexistence issue when using the unlicensed band while the WiFi communication protocol also uses the unlicensed band.

The WiFi communication protocol usually utilizes an operation calls carrier sense multiple access with collision detection (CSMA/CD) mechanism. The CSMA/CD mechanism uses a carrier sense channel, and the device of the WiFi wireless communication system transmits signal only when a channel status is determined to be “idle” as to avoid collision. The “idle” or “busy” states of the carrier sense channel is defined based on a clear channel assessment (CCA) function defined by the WiFi communication protocol. For example, the CCA function may be implemented by reporting busy medium upon detection of an energy level being higher than an energy threshold, or a detection of a recognizable signal with energy level being higher than the energy threshold. The energy threshold may be defined by the WiFi communication protocol, regulations of industrial standards, or laws.

To reduce power consumption, the WiFi wireless communication system utilizes the CSMA/CD mechanism having a virtual carrier sense (VCS). The VCS is a logical concept utilized to reduce power consumption by decreasing the frequency of the physical carrier sense. A header of the MAC layer includes a field having a specific signal transmission time, and the status of the medium is busy during this time period. The base station accesses the field through monitoring the wireless medium and configures a network configuration vector, where the network configuration vector is an indicator of the base station which indicates how much time would be delayed for receiving medium. A header of physical layer further includes a legacy signal field (L-SIG) field utilized for transmission rate and data length of the VCS mechanism.

In addition, the APs of the WiFi wireless communication system uses a mechanism calls dynamic frequency selection (DFS) to satisfy requirements in some regulations for radar detection and uniform channel spreading in the 5 GHz band. The AP of the WiFi communication protocol with DFS may automatically select frequency channel to avoid an operation of sharing a channel with radar system and provide uniform utilization of available channels based on at least one of factors including interference levels, received power levels, reports of CCA, and whether there are radar systems or other APs of WiFi wireless communication system. The APs of the WiFi communication protocol with the DFS mechanism recognizes other APs in the WiFi wireless communication system according to a beacon periodically transmitted by the other APs of the WiFi wireless communication system. The beacon includes system information such as timestamp, beacon gap, capability information, etc.

Next, in order for the LTE wireless network to use the unlicensed band and co-exist with the WiFi wireless communication system, the processor 214 configures a first signal corresponding to the WiFi communication protocol in an idle transmission resource of a second signal corresponding to the LTE communication protocol, or in an idle transmission resource around the second signal corresponding to the LTE communication protocol. Then, the processor 214 transmits, by the transceiver 212, the first signal and the second signal to the unlicensed bands adapted by the WiFi communication protocol, so as to maintain the transmission resources of the base station 200 on the unlicensed bands. The base station 200 selectively or simultaneously utilizes the licensed band and the unlicensed band through the LTE communication protocol and the first and second signal.

In detail, the second signal corresponding to the LTE communication protocol which is transmitted by the LTE wireless network may be wireless network information, control signal, or reference signal, such as discovery reference signal, physical downlink control channel (PDCCH), resource blocks at transaction of downlink to uplink, etc. However, the disclosure is not limited thereto. The first signal corresponding to the WiFi communication protocol which is transmitted by the LTE wireless network in the idle transmission resource of the second signal or the idle transmission resource around the second signal may be system frame, or general information frame or signal. The system frame may be RTS/CTS signal or 802.11 beacon signal. The general information frame or signal may be physical layer header. However, the disclosure is not limited thereto.

As a result, the base station 200 compliant with LTE communication protocol transmits the first signal and the second signal through the unlicensed band. Based on the cooperation of the WiFi communication protocol (i.e., the VCS and DFS mechanisms of the WiFi wireless communication system), usage of the same channel occupied by other devices in the WiFi wireless communication system may be prevented, and the transmission resource of the base station on the unlicensed band may be maintained. The base station 200 may selectively or simultaneously use the licensed bands and the unlicensed bands through the LTE communication protocol and the first and second signals.

For example, FIG. 3 is a diagram illustrating a coexistence of the LTE wireless network and the WiFi wireless communication system in the unlicensed band according to an embodiment of the disclosure. With reference to FIG. 3, a wireless communication network 300 includes two macro base stations (e.g., Macro eNBs), such as base stations 310 and 320. A coverage area of the base station 310 includes two small cell base stations, such as base stations 312 and 314 which use the same unlicensed channel (it should be noted that one unlicensed band includes at least one unlicensed channel). In a coverage area of the base station 320, there is a WiFi AP 322, which searches for usable unlicensed channels according to the VCS and DFS mechanisms of the WiFi wireless communication system. Furthermore, the base station 310 and the base stations 312 and 314 belong to a first operator A, and the base station 320 and the WiFi AP 322 belongs to a second operator B. It should be noted that interference and resource management between the base station 312 and 314 may be operated, managed, and maintained through the first operator A. Thus, there is a backhaul network between the base station 310 and the base station 312 and 314. The control of the user equipments (UEs) serviced by the base station 312 and 314 may be assisted through the base station 310.

However, there may not be backhaul network between the bases station 314 and the WiFi AP 322. In order to prevent the WiFi AP 322 from using the same unlicensed channel as the base stations 312 and 314, the base stations 312 and 314 may configure a multicast broadcast signal frequency network (MBSFN) sub-frame to transmit the system frame, general data frame or signal of the WiFi communication protocol. Furthermore, the system frame, general data frame or signal of the WiFi communication protocol may be transmitted by using the PDCCH, a gap of the discovery reference signal (i.e., idle transmission resource), or a gap of the time-division duplex (TDD) of LTE.

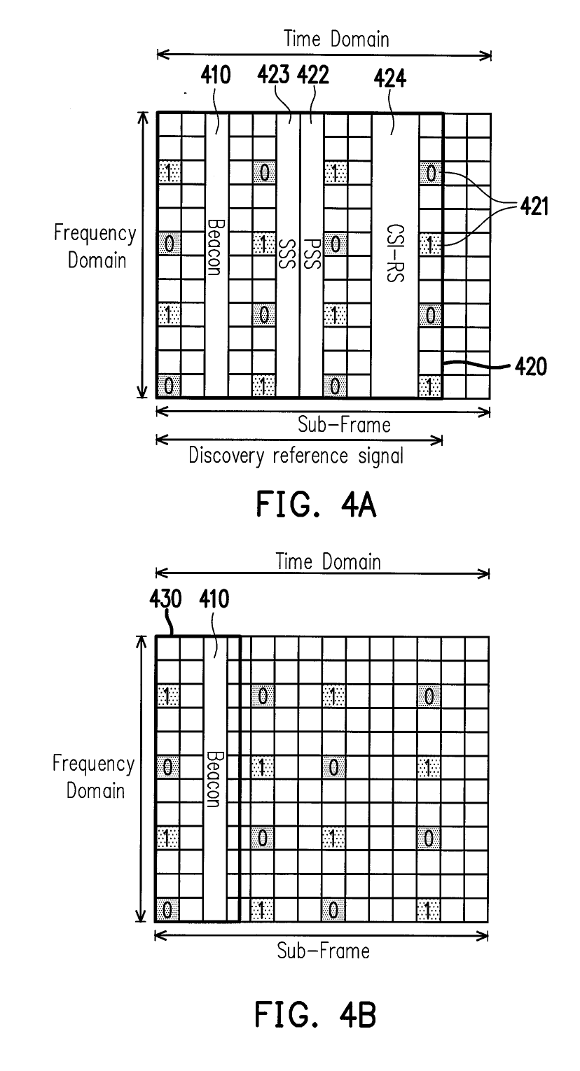

It should be noted that, by transmitting the system frame of the WiFi communication protocol (i.e., RTS/CTS signal or 802.11 beacon), the base stations 312 and 314 may cause the WiFi AP 322 not to first use the channels utilized by the base stations 312 and 314 due to DFS mechanism. For example, FIG. 4A is a diagram illustrating an 802.11 beacon 410 corresponding to the WiFi communication protocol in a discovery reference signal 420 according to an embodiment of the disclosure. FIG. 4B is a diagram illustrating the 802.11 beacon 410 corresponding to the WiFi communication protocol in the PDCCH 430 according to an embodiment of the disclosure. With reference to FIG. 4A, the discovery reference signal 420 of LTE release 12 may be small cell discovery, synchronization, and measure of the reference signal, which includes a cell-specific reference signal (CRS) 421, a primary component carrier (PCC) 422, a secondary component (SCC) 423 and a channel state information reference signal (CSI-RS) 424 occupying discontinuous symbols. Therefore, when the LTE communication protocol transmits the discovery reference signal 420, there are many unused symbols and resources in the sub-frames. Since the European Telecommunication Standards Institute (ETSI) standard defines that the occupied channel bandwidth is a bandwidth having 99% of the power of the signal, and the occupied channel bandwidth should be between 80% to 100% of a specified channel bandwidth. The discovery reference signal 420 of LTE release 12 would increase the requirement for the occupied channel bandwidth. Therefore, as illustrated in FIG. 4A, the base stations 312 and 314 may configure the 802.11 beacon 410 corresponding to WiFi communication protocol in the idle transmission resource of the discovery reference signal 420, so as to fully utilize the resources of the sub-frame of the discovery reference signal 420. Similarly, as illustrated in FIG. 4B, the base stations 312 and 314 may configure the 802.11 beacon 410 corresponding to the WiFi communication protocol in the idle transmission resource of PDCCH 430.

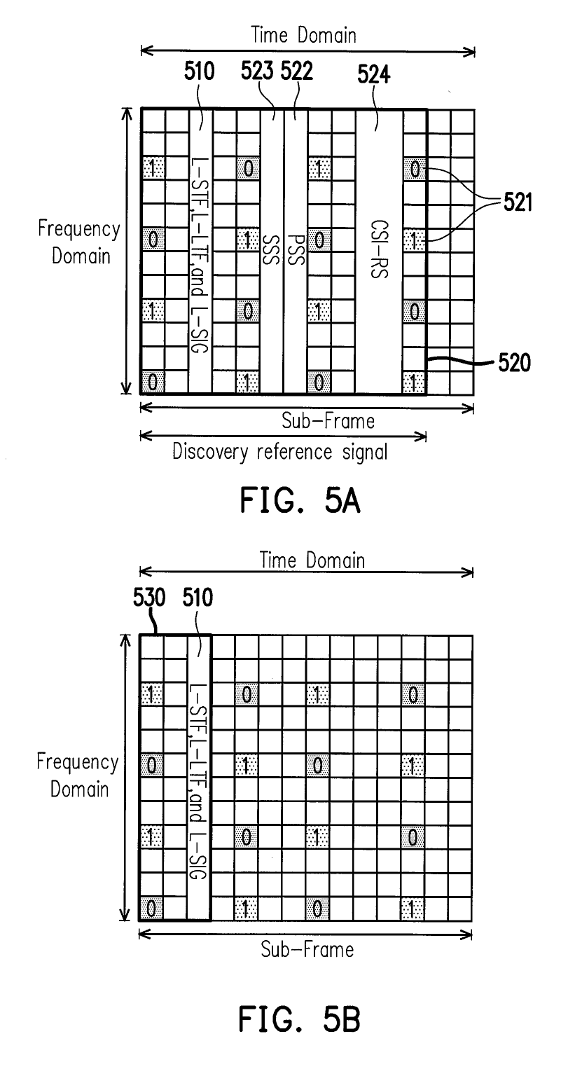

In addition, FIG. 5A is a diagram illustrating an 802.11 physical layer header 510 corresponding to the WiFi communication protocol in the discovery reference signal 520 according to an embodiment of the disclosure. FIG. 5B is a diagram illustrating the 802.11 physical layer header 510 corresponding to the WiFi communication protocol in the PDCCH 530 according to an embodiment of the disclosure. In the embodiment, the base stations 312 and 314 may configure the 802.11 physical layer header 510 in the idle transmission resource of the discovery reference signal 520 or PDCCH 530, so as to fully utilize the resources of the sub-frame. The discovery reference signal 520 illustrated in FIG. 5A may include a cell-specific reference signal (CRS) 521, a primary component carrier (PCC) 522, a secondary component (SCC) 523 and a channel state information reference signal (CSI-RS) 524. However, the disclosure is not limited thereto.

It should be noted that the 802.11 physical layer header 510 may include a Legacy Short Training Field (L-STF), Legacy Long Training Field (L-LTF), and Legacy Signal Field (L-SIG) of the physical layer header compliant with the WiFi communication protocol. The 802.11 physical layer header 510 includes at least one of a channel reservation message, an automatic gain control (AGC) setting, and time and frequency synchronization message, so that the WiFi AP 322 does not first use the channel of the base stations 312 and 314 due to the VCS mechanism.

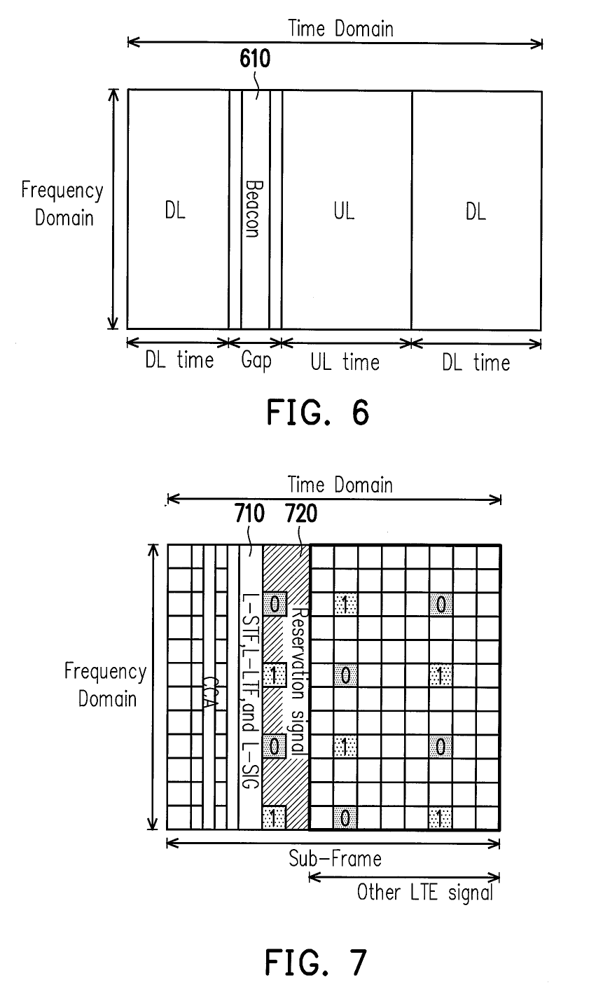

Similarly, in FIGS. 6 and 7, the 802.11 beacon or the physical layer header corresponding to the WiFi communication protocol is transmitted by utilizing the idle transmission resources of the LTE communication protocol. FIG. 6 is a diagram illustrating an 802.11 beacon 610 corresponding to the WiFi communication protocol in a gap of the LTE time division duplex (TDD) according to an embodiment of the disclosure. In FIG. 6, the 802.11 beacon 610 corresponding to the WiFi communication protocol is transmitted by utilizing idle resource of the resource block at transition of uplink to downlink, so as to achieve an effect of fully utilizing the resources of the sub-frames. FIG. 7 is a diagram illustrating an 802.11 physical layer header 710 corresponding to the WiFi communication protocol in a gap of a reservation signal 720 according to an embodiment of the disclosure. If LTE TDD system is utilized, the base stations 312 and 314 may configure a gap of a specific sub-frame or an uplink sub-frame.

Although the WiFi AP 322 still want to use the channel of the base stations 312 and 314, the frame of WiFi communication protocol may be configured in a field for resource reservation or a quiet period (e.g., 802.11h function). The frame may include at least a specific basic service set identification (BSSID) (e.g., 111 . . . 11), a special reservation type value (e.g., a reservation value type=11), and a subtype value of WiFi communication protocol frame structure (e.g., the reservation value of 0110-0111 and 1101-111, type=00), so as to indicate the LTE base stations that utilize the unlicensed band, or indicate information regarding the coexistence of the WiFi wireless communication system and the LTE base station. However, the disclosure is not limited thereto.

Therefore, the frame of the WiFi communication protocol may include an 802.11h measurement report. The 802.11h measurement report may be a basic measurement report of the 802.11h function as to report the existence of other basic service set (BSS). The 802.11h measurement report may be a clearl channel assessment report of the 802.11h function as to report a poor channel condition. The 802.11h measurement report may be a received power indication report of the 802.11h function as to report a poor reception quality. The 802.11h measurement report may indicate that there is a LTE base station using unlicensed channel, or indicate information regarding the coexistence of the WiFi AP and LTE base station. However, the disclosure is intended to limit the 802.11h measurement report.

Thus, the system frame, the general data frame or signal of the WiFi communication protocol may be utilized to maintain the data transmission of base stations on the unlicensed band, such that the base stations may selectively or simultaneously utilize licensed band and unlicensed band through the system frame, the general data frame and signal the WiFi communication protocol and the LTE communication protocol.

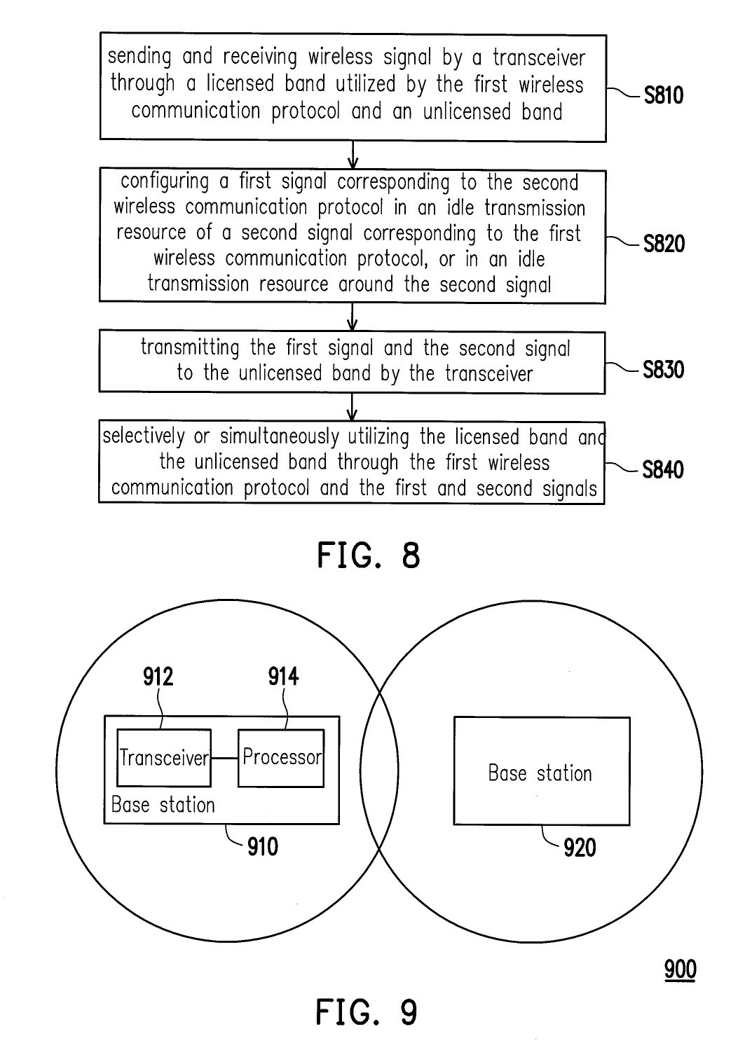

Accordingly, a flow diagram is described below to illustrate a communication method of the base stations of the above embodiments using the first wireless communication protocol in the unlicensed band. FIG. 8 is a flow diagram illustrating a communication method of a base station using a first wireless communication protocol on an unlicensed band according to an embodiment of the disclosure. In step 810, the base station transmits and receives wireless signal by a transceiver through a licensed band utilized by the first wireless communication protocol and an unlicensed band. The unlicensed band is adopted/employed by a second wireless communication protocol, and the first wireless communication protocol and the second wireless communication protocol employ different radio access technique. In step 820, a processor of the base station configures a first signal corresponding to the second wireless communication protocol in an idle transmission resource of a second signal corresponding to the first wireless communication protocol, or in an idle transmission resource around the second signal. In step 830, the base station transmits the first signal and the second signal to the unlicensed band by the transceiver, where the first signal and the second signal are utilized to maintain the transmission resource on the unlicensed band. In step 840, the base station may selectively or simultaneously utilize the licensed band and the unlicensed band through the first wireless communication protocol and the first and second signals.

In short, embodiments of the disclosure provides an base station and radio communication technique that signals corresponding to the second wireless communication protocol may be transmitted through the idle transmission resource of the first wireless communication protocol. Additionally, the VCS, DFS, other sharing mechanisms of the second wireless communication protocol may be utilized to prevent a device using the second wireless communication protocol from using the same channel. In this way, the base station may transmits and receives radio signals through the licensed band using the first communication protocol and the unlicensed band using the second wireless communication protocol, so as to selectively or simultaneously use the licensed band and the unlicensed band.

On the other hand, in a case when base stations using LTE communication protocol belonging to different operators are to use the unlicensed band, interference and channel sharing mechanisms between the base stations belonging to different operators may be explained in detail through the following embodiments.

FIG. 9 is a diagram illustrating a communication of a base station adapted to LTE communication protocol using unlicensed band 900 according to an embodiment of the disclosure. In the embodiment, a coverage area of the unlicensed band 900 includes base stations (eNB) 910 and 920. In the embodiment, the base stations 910 and 920 are embodied in a similar manner, and thus characteristics of the embodiment are described by using the base station 920 as example. The base station 910 is in compliance with a first wireless communication protocol, where the first wireless communication protocol may be, but not limited to, LTE, WiMAX, cellular wireless access network, etc.

The base station 910 includes a transceiver 912 and a processor 914. The processor 914 is coupled to the transceiver 912. The processor 914 executes a wireless communication function of the base station 910. The transceiver 912 sends and receives wireless signals through the unlicensed band 900. However, it should be noted that the unlicensed band is also adopted by a second wireless communication protocol, and the first wireless communication protocol and the second wireless communication protocol use different radio access techniques. In the embodiment, the second wireless communication protocol may be, for example, a wireless area network protocol compliant with IEEE 802.11 standard. However, the disclosure is not limited thereto.

For the purpose of illustration, but not limited to, the first and second wireless communication protocols are respectively LTE communication protocol and WiFi communication protocol. As described above, the base station 910 may be a combination of a base station compliant with the LTE communication protocol and an AP compliant with the WiFi communication protocol.

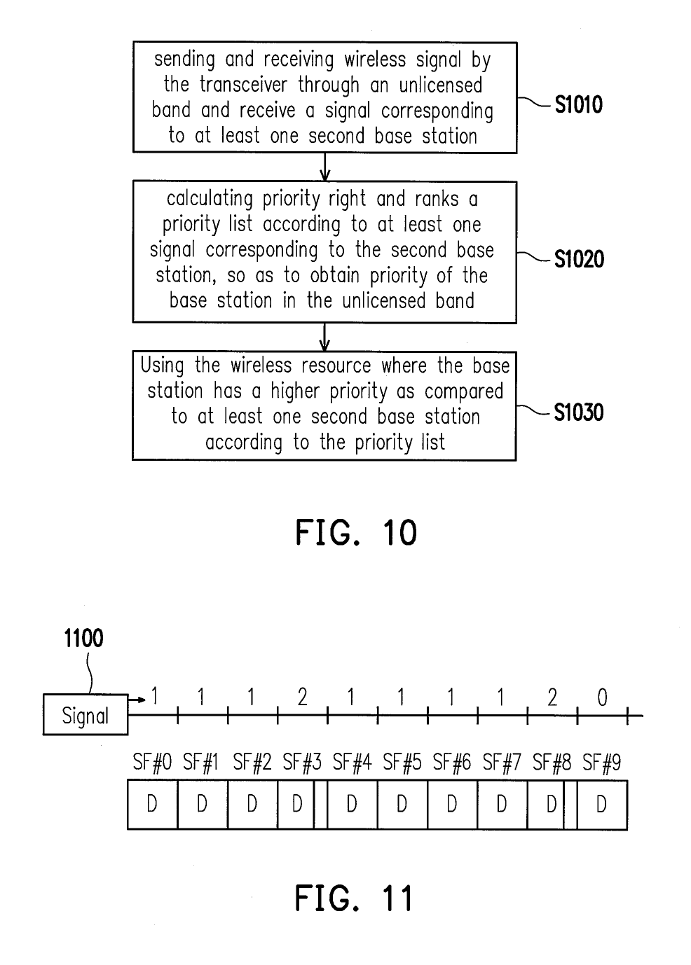

FIG. 10 is a flow diagram illustrating a communication method between base stations 910 and 920 according to an embodiment of the disclosure. The method of the embodiment may be embodied by the base stations 910 and 920. In the following, the communication method between the base stations 910 and 920 is described with each components of the base station 910.

In step S1010, the base station 910 (also referred to as a first base station) sends and receives wireless signal by the transceiver 912 through an unlicensed band and receive a signal corresponding to at least one second base station. In addition to sending and receiving wireless signals through the unlicensed band, the base station 910 may also receive signals for reserving wireless resource transmitted by the base station 920. It should be noted that the base station 910 may receive signals for reserving wireless resource transmitted by other base stations; however, it is not intended to limit the disclosure. In order to convey the spirit of the embodiment, the base station 910 is utilized as example to describe the communication method between the base stations.

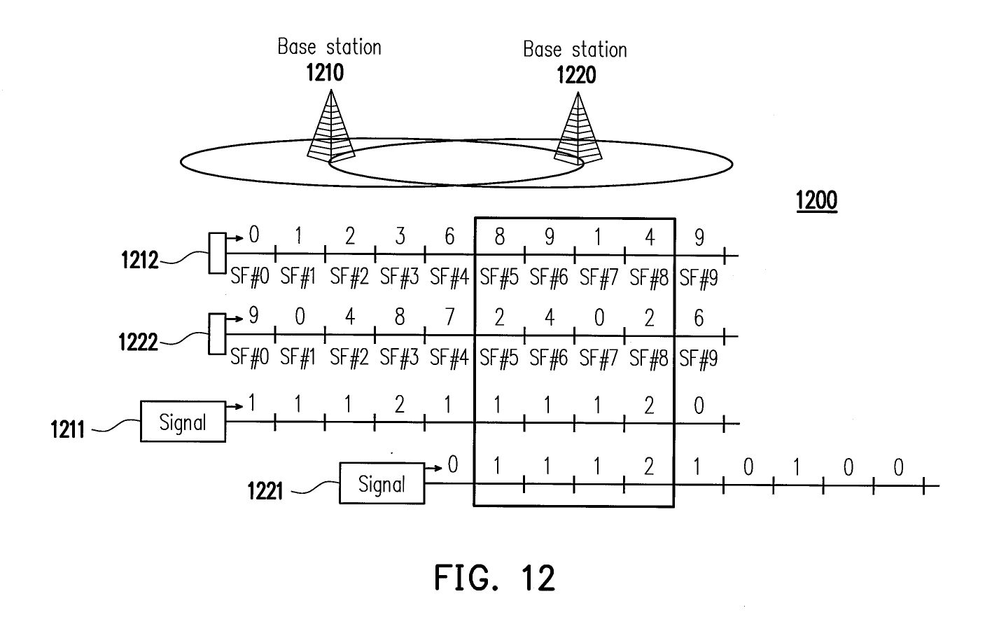

In the embodiment, a sub-frame transmitted by the base station 910 may reserve a part of or the last symbol, so that the base station 920 may transmit a signal for reserving wireless resources. FIG. 11 is a diagram illustrating a sub-frame transmitted by the base station 910 according to an embodiment of the disclosure. The sub-frames SF#0-SF#9 transmitted by the base station 910 include transmitted data D, as well as a signal 1100 having information related to wireless resource reservation. The signal 1100 utilizes numbers such as 0, 1, and 2 to respectively represent status such as unreserved wireless resource, reserved wireless resource, and reserved but reserving the last symbol for other base station that transmits the signal for reserving the transmission resource. After the base station 920 receives the sub-frames SF#0-SF#9 transmitted by the base station 910, the base station 920 decodes and analyzes the reserved and unreserved wireless resources of the base station 910 to find an opportunity for transmitting a reservation signal. Since the base station 920 may decode the signal 1100 to find that the sub-frame SF#3 or SF#8 has a value of 2 (i.e., the value of 2 represents that those sub-frames are reserved but reserving the last symbol for other base stations that transmits reservation signal), the base station 920 may transmit the reservation signal in last symbol of the sub-frames SF#3 or SF#8. It should be noted that the base stations compliant with LTE communication protocol and belonging to the same operators though multiplexing or a signal combining a plurality of reservation signals. Furthermore, the signal is a periodically signal, the signal further includes a periodical duration information.

In other embodiments of the disclosure, the signal related to wireless resource reservation transmitted by each base station may be configured in an idle transmission resource of the signal corresponding to the LTE communication protocol or an idle transmission resource around the signal corresponding to the LTE communication protocol. The signal corresponding to the LTE communication protocol may be, but not limiting, discovery reference signal, PDCCH signal, idle resource of resource block at transition of downlink to uplink, which are illustrated in FIGS. 4-7.

On the other hand, the signal related to wireless resource reservation at least includes one of priority list, cell identifier (cell ID), device identification number, operation identification number, system frame number, signal code, time information, frequency information or random number. Since the device of the LTE wireless communication system may not transmit or receive freely at any given time in the unlicensed band, the base station 910 may schedule the communication according to the signal related to the wireless resource reservation transmitted by the base station 920, so as to share (or co-exist) the channel in the unlicensed band.

In step S1020, the base station 910 calculates priority right and ranks a priority list according to at least one signal corresponding to the second base station, so as to obtain priority of the base station in the unlicensed band. In step S1030, the base station 910 uses the wireless resource where the base station 910 has a higher priority as compared to at least one second base station according to the priority list.

In the embodiment, the processor 914 of the base station 910 further calculates priority according to the signal related to wireless resource reservation transmitted by the base station 920 and ranks a priority list. The signal related to the wireless resource reservation may include, but not limit to, priority list, cell ID, device identification number, operator identification number, system frame number, signal number, time information, frequency information, or random number, and accordingly, the base station 910 may calculate the priority. However, the disclosure is not intended to limit the method of calculating the priority. Afterward, after the bases station 910 acquires the priority list for using the unlicensed band, the base station 910 may use the wireless resource where the base station 910 has higher priority as compared to the base station 920 according to the priority list. In addition, the base station 910 may also reserve wireless resource to the base station 920 in the unlicensed band according to the priority. It should be noted that the base station 910 may also reverse wireless resource to the base station 920 through exchanging information or other manner The disclosure is not limited thereto.

For example, FIG. 12 is a diagram illustrating sharing of unlicensed band by base stations according to an embodiment of the disclosure. With reference to FIG. 12, the unlicensed band 1200 may be utilized by two small cell base stations, such as base stations 1210 and 1220. The base station 1210 belongs to a first operator A, and the base station 1220 belongs to a second operator B. There is no backhaul network between the base stations 1210 and 1220. For example, the base station 1210 uses a channel of the unlicensed band, and the base station 1220 is a newly added base station to the network, where the base station 1220 is to use the same channel of the unlicensed band as the base station 1210. After the base station 1220 receives and decodes a signal related to wireless resource reservation transmitted by the base station 1210, a signal 1221 is transmitted in a sub-frame SF#3 as to reserve a channel in the unlicensed band being utilized by the base station 1210. After the base station 1210 receives the signal 1221 transmitted by the base station 1220, the base station 1210 decodes the signal 1221 and calculates a priority as to rank a new priority list 1212. As a result, the base station 1210 may have priority to use the wireless resource where the base station 1210 has higher priority in the new priority list 1212 as compared to a priority list 1222 of the base station 1220.

It should be noted that since an order of the priority in the priority lists 1212 and 1222 is ranked from small to big, a base station corresponding to a lower ordered number has a higher priority. However, the disclosure is not limited thereto. With reference to FIG. 12, since the priority order of the sub-frames SF#5, SF#6, SF#7, and SF#8 in the priority list 1222 of the base station 1220 is lower than the priority order in the priority list 1212 of the base station 1210, the base station 1220 has higher priority in the sub-frames SF#5, SF#6, SF#7, and SF#8 as opposed to the base station 1210. As such, the base station 1210 allows the base station 1220 to first use the wireless resource of the sub-frames SF#5, SF#6, SF#7, and SF#8 in the unlicensed base, or use beamforming or other power control method to use the wireless resource. The disclosure is not intended to limit thereto.

In addition, regarding a random backoff window mechanism in the unlicensed band, based on the contention, the backoff window is usually relied upon to resolve the contention while random access process. However, in an embodiment of the disclosure, the priority lists 1212 and 1222 between the base stations 1210 and 1220 may be utilized to replace the contention mechanism. Therefore, in the embodiment, if the base station 1210 has a higher priority to the wireless resource as opposed to the base station 1220 (e.g., sub-frames SF#0, SF#1, SF#2, and SF#4), the base station 1210 uses a shorter backoff window or not use the backoff window to the wireless resources having higher priority, and the base station 1220 then uses a longer backoff window, so that the base station 1220 continuously monitors whether the base station is using the wireless resource. In other words, if the base station 1210 has lower priority to the wireless resource as opposed to the base station 1220 (e.g., sub-frames SF#5, SF#6, SF#7, and SF#8), the base station 1210 uses a longer backoff window for the wireless resource having a lower priority, so that the base station 1210 continuously monitors whether the base station 1220 is using the wireless resource, and the base station 1220 either uses a shorter backoff window or not use the backoff window. However, the disclosure is not limited thereto.

In short, the embodiment of the disclosure set forth a base station, where the base station may transmit signals related to wireless resource reservation on the unlicensed band, so that the base station may acquire a priority list and reserve wireless resource. As a result, the base stations belonging to different operators may uses the wireless resources on the unlicensed band without contention.

It should be noted that an UE may be coupled to one of the base stations 910, 920, 1210, and 1220 described above. In an embodiment describing a communication method of the UE, the UE is coupled to a base station (also referred to as coupled base station), the UE may receive a signal related to the wireless resource reservation of the coupled base station. According to the signal, priority of the coupled base station in the wireless communication system may be acquired, and reserved wireless resource of the coupled base station may be known according to the priority. When the wireless resource is not reserved by the coupled base station, the UE would not receive signals from the coupled base station, so as to reduce power. In addition, when the UE receives the signal related to the wireless resource reservation of the corresponding base station, the UE may calculate and transmit another signal having the priority list of at least one neighboring base station to the coupled base station according to the received signal.

Base on the above, the embodiments of the disclosure set forth a base station and a communication method thereof. The base station may send and receive wireless signals according to a licensed band and an unlicensed band adopted by a first wireless communication protocol, wherein the unlicensed band is also adopted by a second wireless communication protocol. The base station may also avoid using the same channel as other devices using the second wireless communication protocol by adapting VCS, DFS, or other sharing mechanisms of the second wireless communication protocol. Furthermore, base stations between different operators may acquire priority list and reserve wireless resources by transmitting signal related to wireless resource reservation. As a result, the base station may selectively or simultaneously use the licensed band and the unlicensed band. Furthermore, the base stations belong to different operators that utilizes the unlicensed band may use the wireless resources on the unlicensed band according to the priority test without contention. In addition, an UE of the disclosure may determine whether to receive information according a signal related to wireless resource transmitted by a coupled base station, so as to achieve an effect of power reduction.

It will be apparent to those skilled in the art that various modifications and variations can be made to the structure of the disclosure without departing from the scope or spirit of the disclosure. In view of the foregoing, it is intended that the disclosure cover modifications and variations of this disclosure provided they fall within the scope of the following claims and their equivalents.

What is claimed is:

1. A base station, adapted to a first wireless communication protocol, the base station comprising:
a transceiver, sending and receiving wireless signals through a licensed band and an unlicensed band adopted by a first wireless communication protocol, wherein the unlicensed band is also adopted by a second wireless communication protocol, and the first wireless communication protocol and the second wireless communication protocol use different radio access techniques; and
a processor, coupled to the transceiver,
wherein the processor configures a first signal corresponding to the second wireless communication protocol in an idle transmission resource of a second signal corresponding to the first wireless communication protocol or an idle transmission resource around the second signal, transmits the first signal and the second signal through the transceiver to the unlicensed band to maintain transmission resources of the base station on the unlicensed band, and selectively or simultaneously uses the licensed band and the unlicensed band through the first wireless communication protocol and the first signal and the second signal.

2. The base station as claimed in claim 1, wherein the first wireless communication protocol is one of Long Term Evolution (LTE) protocol, Worldwide Interoperatbility for Microwave Access (WiMAX) protocol, and cellular radio access network.

3. The base station as claimed in claim 1, wherein the second wireless communication protocol is a wireless area network protocol compliant with IEEE 802.11.

4. The base station as claimed in claim 2, wherein the second signal is discovery reference signal, physical downlink control channel (PDCCH), resource block of uplink to downlink, or other reference signal.

5. The base station as claimed in claim 3, wherein the first signal is an 802.11 beacon or an 802.11 physical layer header.

6. The base station as claimed in claim 5, wherein the 802.11 physical layer header at least comprises one of channel reservation message, an automatic gain control setting, and time and frequency synchronization message.

7. A communication method, adapted to a base station using a first wireless communication protocol, comprising:
sending and receiving wireless signal, by a transceiver, through a licensed band and an unlicensed band adapted by the first wireless communication protocol, wherein the unlicensed band is also adapted by a second wireless communication protocol, and the first wireless communication protocol and the second wireless communication protocol uses different radio access technique;
configuring a first signal corresponding to the second wireless communication protocol in an idle transmission resource of a second signal corresponding to the first wireless communication protocol or an idle transmission resource around the second signal;
transmitting the first signal and the second signal, by the transceiver, to the unlicensed band, wherein the first signal and the second signal are utilized to maintain transmission resource of the base station on the unlicensed band; and
selectively or simultaneously using the licensed band and the unlicensed band through the first wireless communication protocol and the first signal and the second signal.

8. The communication method as claimed in claim 7, wherein the first wireless communication protocol is one of Long Term Evolution (LTE) protocol, Worldwide Interoperatbility for Microwave Access (WiMAX) protocol, and cellular radio access network.

9. The communication method as claimed in claim 7, wherein the second wireless communication protocol is a wireless area network protocol compliant with IEEE 802.11.

10. The communication method as claimed in claim 8, wherein the second signal is discovery reference signal, physical downlink control channel (PDCCH), resource block of uplink to downlink, or other reference signal.

11. The communication method as claimed in claim 9, wherein the first signal is an 802.11 beacon or an 802.11 physical layer header.

12. The communication method as claimed in claim 11, wherein the 802.11 physical layer header at least comprises one of channel reservation message, an automatic gain control setting, and time and frequency synchronization message.

13. A base station, adapted to a first wireless communication protocol, wherein the base station uses the first wireless communication protocol to communication with at least one second base station, wherein the first base station comprises:
a transceiver, sending and receiving wireless signal through an unlicensed band and receiving a signal from the at least one second base station; and
a processor, coupled to the transceiver,
wherein the processor calculates a priority according to the signal from the at least one second base station and ranking a priority list to acquire the priority of the base station in the unlicensed band, the processor first uses a transmission resource having higher priority as compared to the at least one second base station according to the priority list.

14. The base station as claimed in claim 13, wherein the processor further reserve the transmission resource in the unlicensed band to the at least one second base station according to the priority.

15. The base station as claimed in claim 13, wherein the first wireless communication protocol is one of Long Term Evolution (LTE) protocol, Worldwide Interoperatbility for Microwave Access (WiMAX) protocol, and cellular radio access network.

16. The base station as claimed in claim 15, wherein the signal is configured in an idle transmission resource around or of a discovery reference signal, physical downlink control channel (PDCCH), resource block of uplink to downlink, or other reference signal corresponding to the first wireless communication protocol.

17. The base station as claimed in claim 13, wherein the signal at least comprises one of the priority list, cell identifier (cell ID), device identification number, operator identification number, system frame number, time information, frequency information and random number.

18. The base station as claimed in claim 13, wherein the base station has higher priority to use the wireless resource as compared to the at least one second base station, the base station uses a shorter backoff window or not uses the backoff window to the wireless resource with higher priority, and the at least one second base station uses a longer backoff window.

19. The base station as claimed in claim 13, wherein the signal is a periodically signal having periodical duration information.

20. The bases station as claimed in claim 13, wherein the first wireless communication protocol further reserve a part of sub-frame or last symbol for the at least one second base station to transmit the signal.

21. A communication method, adapted to a base station using a first wireless communication protocol, wherein the base station uses the first wireless communication protocol to communication with at least one second base station, wherein the communication method comprises:
sending and receiving wireless signal through a transceiver in an unlicensed band and receiving a signal corresponding to at least one second base station;
calculating a priority according to the signal corresponding to the at least one second base station, ranking a priority list to acquire a priority of the base station in the unlicensed band; and
using wireless resource in which the base station has higher priority as compared to the at least one second base station according to the priority list.

22. The communication method as claimed in claim 21, wherein the method further comprises reserving the wireless resource in the unlicensed band to the at least one second base station according to the priority.

23. The communication method as claimed in claim 21, wherein the first wireless communication protocol is one of Long Term Evolution (LTE) protocol, Worldwide Interoperatbility for Microwave Access (WiMAX) protocol, and cellular radio access network.

24. The communication method as claimed in claim 23, wherein the signal is configured in an idle transmission resource around or of a discovery reference signal, physical downlink control channel (PDCCH), resource block of uplink to downlink, or other reference signal corresponding to the first wireless communication protocol.

25. The communication method as claimed in claim 21, wherein the signal at least comprises one of the priority list, cell identifier (cell ID), device identification number, operator identification number, system frame number, time information, frequency information and random number.

26. The communication method as claimed in claim 21, wherein the base station has higher priority to use the wireless resource as compared to the at least one second base station, the base station uses a shorter backoff window or not use the backoff window to the wireless resource with higher priority, and the at least one second base station uses a longer backoff window.

27. The communication method as claimed in claim 21, wherein the signal is a periodically signal having periodical duration information.

28. The communication method as claimed in claim 21, wherein the first wireless communication protocol further reserve a part of sub-frame or last symbol for the at least one second base station to transmit the signal.

29. A communication method, adapted to user equipment (UE), comprising:
receiving a signal from a base station connected to the UE;
acquiring a priority within a wireless communication system according to the signal and finding out reserved wireless resource of the base station according to the priority; and
not receiving message from the base station by the UE to reduce power consumption in the reserved wireless resource of the base station.

30. The communication method as claimed in claim 29, wherein the step of acquiring a priority within a wireless communication system according to the signal and finding out reserved wireless resource of the base station according to the priority comprises:
Calculating and sending a signal including a priority list of at least one neighbouring base station to the base station connected to the UE.
